(19) United States
(12) Patent Application Publication
(10) Pub. No.: US 2021/0210761 A1
(43) Pub. Date: Jul. 8, 2021

(54) LITHIUM ION SECONDARY BATTERY, ELECTRODE AND METHOD FOR PRODUCING SAME

(71) Applicant: NEC ENERGY DEVICES, LTD., Sagamihara-shi, Kanagawa (JP)

(72) Inventor: Kazuya MIMURA, Sagamihara-shi (JP)

(73) Assignee: NEC ENERGY DEVICES, LTD., Sagamihara-shi, Kanagawa (JP)

(21) Appl. No.: 16/087,357

(22) PCT Filed: Mar. 6, 2017
(86) PCT No.: PCT/JP2017/008812

§ 371 Date: Sep. 21, 2018

(30) Foreign Application Priority Data
Mar. 24, 2016 (JP) 2016-060266

(51) Int. Cl. H01M 4/62; H01M 10/0525; H01M 50/572

(52) U.S. Cl. CPC H01M 4/62; H01M 2004/028; H01M 50/572; H01M 10/0525

(57) ABSTRACT

An electrode comprising an active material layer comprising an active material and a first resin, the active material layer being formed on at least one surface of a current collector, and an active material layer non-formation portion having no active material layer formed thereon, wherein a boundary between the active material layer and the active material layer non-formation portion is covered with an insulating layer, and the insulating layer comprises a third resin; and a heat resistant layer covering the surface of the active material layer is formed, the heat resistant layer overlaps with the insulating layer at an end portion of the active material layer, and the heat resistant layer comprises a fourth resin.

### TECHNICAL FIELD

The present invention relates to a lithium ion secondary battery, an electrode and a method for producing the same.

### BACKGROUND ART

A lithium ion secondary battery has a small size, lightweight and large energy density. Because of this, the lithium ion secondary battery is widely used as power supplies including a power supply for mobile equipment such as smartphones and game instruments; a power supply for driving motors installed in vehicles; a backup power supply for commercial use, and further, as storage batteries for partly providing electricity of houses and buildings.

In the lithium ion battery, a power generating element is generally formed by alternately stacking positive electrodes and negative electrodes with a separator interposed between each of them, or winding a laminate prepared by stacking a positive electrode and a negative electrode via a separator. In a positive electrode and a negative electrode facing each other, generally the active material layer of the negative electrode is increased in area to prevent precipitation of lithium during the charge/discharge process of the battery.

An electrode such as a positive electrode and a negative electrode of a lithium ion secondary battery is formed by continuously or discontinuously applying a slurry comprising, e.g., an active material and a binder, to one or both surfaces of a long-foil current collector and drying the slurry. The active material layer is further compressed to enhance adhesion between mutual active-material particles and adhesion between the active material particles and a current collector, thereby reducing electrical contact resistance and improving energy density.

The positive electrode and negative electrode each have a portion at which the active material layer is present on the foil-form current collector and a portion at which the active material layer is not present on the foil-form current collector. The portion at which the active material is not present serves as an electrode leader tab, which is pulled out from the power generating element and connected to an electrode terminal. The power generating element is housed together with an electrolytic solution in an outer case, resulting in a structure where electrode terminals are pulled out from the outer case and placed outside.

Recently, with an improvement in energy density of batteries, improvement in safety thereof has been further strongly required. One of the safety measures is suppressing contact of a portion of a current collector having no active material layer formed thereon with a different polarity. To attain this, a technique for forming an insulating member on the boundary between a portion having the active material layer formed thereon and a portion not having active material layer formed thereon, is proposed. Due to this, if heat generates in a battery for some unknown reason and the separator shrinks and is smaller than the active material layer, short circuit can be prevented by the insulating member. Note that, the insulating member is locally formed only on the boundary between a portion having the active material layer formed thereon and a portion not having the active material layer formed thereon. Because of this, the thickness of the power generating element differs between a portion having the insulating member and the portion having no insulating member when electrodes are stacked or wound. As a result, the battery characteristics may be deteriorated. As a technique to overcome this, reducing thickness of the active material layer on the boundary, and then, attaching an insulating tape to the portion reduced in thickness, is proposed (Patent Literature 1).

Another safety measure is suppressing thermal runaway when short circuit occurs between a positive electrode and a negative electrode through a separator, between the main surfaces of electrode active material layers facing each other via a separator. To attain this, a technique for forming a resistant layer comprising, e.g., insulating particles, on the active material to interpose a heat resistant layer in order to suppress thermal runaway by short circuit between a positive electrode and a negative electrode, even if the separator excessively shrinks or disappears at high temperature, is disclosed (Patent Literature 2).

FIG. 9 is an enlarged sectional view showing an electrode end portion of a related lithium ion secondary battery where a heat resistant layer is formed on the electrode. FIG. 10 is an enlarged sectional view showing an electrode end portion of a related lithium ion secondary battery where a heat resistant layer and an insulating layer are formed on the electrode.

### CITATION LIST

### Patent Literature

Patent Literature 1: WO 2013/137385A1
Patent Literature 2: JP H7-220759A

### SUMMARY OF INVENTION

### Technical Problem

However, when a heat resistant layer comprising, e.g., insulating particles and an insulation tape are formed on the active material layer, since the heat resistant layer and the insulation tape are poor in adhesion, the heat resistant layer and the insulation tape may separate at a contact portion of them. If the insulation tape that is separated and ceramic particles contained in the heat resistant layer come into contact with a power generating element, electrical characteristics and cycle characteristic may be affected. In contrast, providing an excessively large space between the heat resistant layer and the insulation tape to avoid contact of them, is not satisfactory in view of safety.

In the circumstances, an object of the present invention is to provide a highly safe electrode and secondary battery without having an effect on the electrical characteristics even if a heat resistant layer and an insulating layer are provided.

### Solution to Problem

According to an aspect, there is a provided a lithium ion secondary battery comprising:

a positive electrode comprising a positive electrode active material layer comprising a positive electrode active material and a first resin, the positive electrode active material layer being formed on at least one surface of a positive electrode current collector, and a positive electrode active material layer non-formation portion having no positive electrode active material layer formed thereon;

a negative electrode comprising a negative electrode active material layer comprising a negative electrode active material and a second resin, the negative electrode active material layer being formed on at least one surface of a negative electrode current collector, and a negative electrode active material layer non-formation portion having no negative electrode active material layer formed thereon; and

a separator,

wherein the positive electrode and the negative electrode mutually face, with the separator interposed therebetween;

a boundary between the positive electrode active material layer and the positive electrode active material layer non-formation portion is covered with an insulating layer, and the insulating layer comprises a third resin; and

a heat resistant layer covering the surface of the positive electrode active material layer is formed, the heat resistant layer overlaps with the insulating layer at an end portion of the positive electrode active material layer, and the heat resistant layer comprises a fourth resin.

According to another aspect, there is a provided a lithium ion secondary battery comprising:

a positive electrode comprising a positive electrode active material layer comprising a positive electrode active material and a first resin, the positive electrode active material layer being formed on at least one surface of a positive electrode current collector, and a positive electrode active material layer non-formation portion having no positive electrode active material layer formed thereon;

a negative electrode comprising a negative electrode active material layer comprising a negative electrode active material and a second resin, the negative electrode active material layer being formed on at least one surface of a negative electrode current collector, and a negative electrode active material layer non-formation portion having no negative electrode active material layer formed thereon; and

a separator,

wherein the positive electrode and the negative electrode mutually face, with the separator interposed therebetween;

a boundary between the positive electrode active material layer and the positive electrode active material layer non-formation portion is covered with an insulating layer, and the insulating layer comprises a third resin; and

a heat resistant layer is formed so as to cover part or whole of the insulating layer as well as the surface of the positive electrode active material layer, and the heat resistant layer comprises a fourth resin.

According to another aspect, there is provided an electrode comprising an active material layer comprising an active material and a first resin, the active material layer being formed on at least one surface of a current collector, and an active material layer non-formation portion having no active material layer formed thereon,

wherein a boundary between the active material layer and the active material layer non-formation portion is covered with an insulating layer, and the insulating layer comprises a third resin; and

a heat resistant layer covering the surface of the active material layer is formed, the heat resistant layer overlaps with the insulating layer at an end portion of the active material layer, and the heat resistant layer comprises a fourth resin.

According to another aspect, there is provided a method for producing the electrode mentioned above, the method comprising:

forming an active material layer on a current collector;

forming an insulating layer on an end portion of the active material layer so as to cover a boundary between an active material layer formation portion and an active material layer non-formation portion on the current collector; and

forming a heat resistant layer on the active material layer.

According to another aspect, there is provided an electrode comprising an active material layer comprising an active material and a first resin, the active material layer being formed on at least one surface of a current collector, and an active material layer non-formation portion having no active material layer formed thereon,

wherein a boundary between the active material layer and the active material layer non-formation portion is covered with an insulating layer; the insulating layer comprises a third resin; and

the heat resistant layer is formed so as to cover part or whole of the insulating layer as well as the surface of the active material layer, and the heat resistant layer comprises a fourth resin.

### Advantageous Effects of Invention

According to exemplary embodiments, a highly safe electrode and secondary battery can be provided without having an effect on electrical characteristics even if a heat resistant layer and an insulating layer are provided.

### BRIEF DESCRIPTION OF DRAWINGS

FIG. 1 is a schematic sectional view schematically showing a basic structure of a lithium ion secondary battery according to an exemplary embodiment.

FIG. 2 is an enlarged sectional view schematically showing an end portion of the electrode according to a first exemplary embodiment.

FIG. 3 is an enlarged sectional view schematically showing an end portion of the electrode according to a second exemplary embodiment.

FIG. 4 is an enlarged sectional view schematically showing an end portion of the electrode according to a third exemplary embodiment.

FIG. 5 is a schematic view illustrating a process for producing an electrode according to an exemplary embodiment.

FIG. 6 is a schematic view illustrating a process for producing an electrode according to an exemplary embodiment.

FIG. 7 is a schematic view illustrating a process for producing an electrode according to an exemplary embodiment.

FIG. 8a is a schematic view illustrating a process for producing an electrode according to an exemplary embodiment.

FIG. 8b is a schematic view illustrating a process for producing an electrode according to an exemplary embodiment.

FIG. 9 is an enlarged sectional view showing an electrode end portion of a related associating lithium ion secondary battery where a heat resistant layer is formed on the electrode.

FIG. 10 is an enlarged sectional view showing an electrode end portion of a related lithium ion secondary battery where a heat resistant layer and an insulating layer are formed on the electrode.

### DESCRIPTION OF EMBODIMENTS

The lithium ion secondary battery according to a first aspect may have the following structure.

The insulating layer covers the boundary between the positive electrode active material layer formation portion and non-formation portion thereof on at least one surface of a positive electrode current collector.

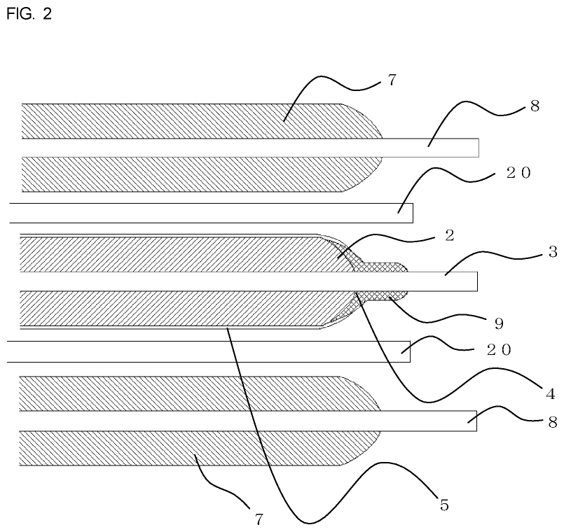

There can be provided a structure where a heat resistant layer is formed so as to cover the positive electrode active material layer and the heat resistant layer can be formed so as to cover part (end portion) or whole of the insulating layer. For example, as shown in FIG. 2, the surface of the positive electrode active material layer can be covered with the heat resistant layer and the insulating layer such that the surface of the positive electrode active material layer is not exposed.

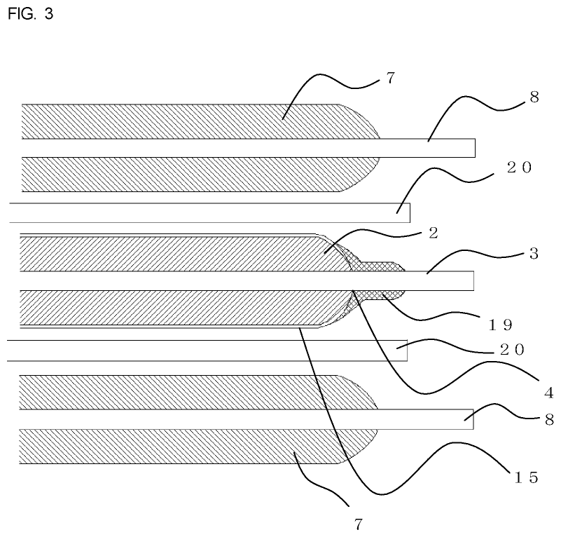

Alternatively, there can be provided a structure where the heat resistant layer covering the positive electrode active material layer is formed and the insulating layer covers part (end portion) of the heat resistant layer. For example, as shown in FIG. 3, the surface of the positive electrode active material layer can be covered with the heat resistant layer and the insulating layer such that the surface of the positive electrode active material layer is not exposed.

The positive electrode active material layer may have an inclined portion gradually reduced in thickness toward an end portion of the positive electrode active material layer non-formation portion side.

In this case, one end of the insulating layer may be positioned on the inclined portion, and the other end may be formed on the surface of the positive electrode current collector (positive electrode active material layer non-formation portion).

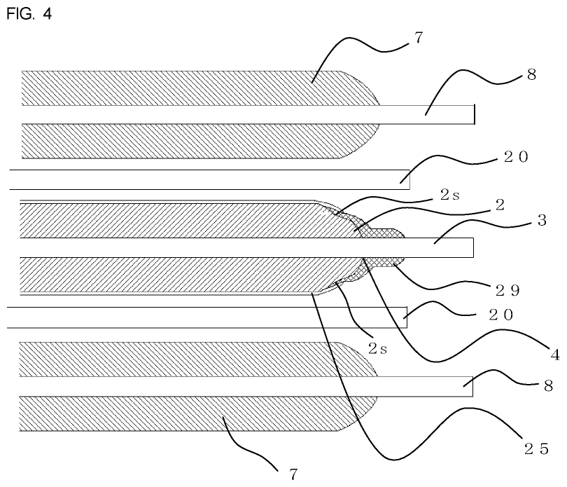

The inclined portion may further have a stepped portion. The stepped portion may be formed of a portion comprising a surface having a large inclination angle relative to the plane of the current collector and a surface having a small inclination angle to the plane, the surfaces being continuously formed, for example, like a portion represented by reference symbol 2s in FIG. 4. The stepped portion corresponds to a recess present along the longitudinal direction of the inclined portion (the direction along the end portion of the positive electrode active material layer: the direction from the front of the paper of the drawing toward the back in FIG. 4). The depth of the recess is preferably the same or more as the thickness of the insulating layer or the heat resistant layer on the positive electrode active material layer, and more preferably, the same as the total thickness of the insulating layer and the heat resistant layer on the positive electrode active material layer. At this time, the depth of the recess is preferably the same or less as the total thickness of the insulating layer and the heat resistant layer on the positive electrode active material layer plus the thickness of the insulating layer or the heat resistant layer. Since an end portion of the insulating layer and an end portion of the heat resistant layer are stacked at the recess, a local increase in thickness can be suppressed. As a result, a more highly reliable battery can be provided.

The first resin, third resin and fourth resin each are preferably a fluororesin.

One end of the heat resistant layer is positioned on the surface of the positive electrode active material layer at the inclined portion and the end of the heat resistant layer can be covered with the insulating layer (for example, the structure shown in FIG. 3).

One end of the insulating layer is positioned on the surface of the positive electrode active material layer at the inclined portion and the end of the insulating layer can be covered with the heat resistant layer (for example, the structure shown in FIG. 2).

The electrode according to a second aspect may have the following structure.

The insulating layer covers the boundary between the active material layer formation portion and non-formation portion thereof on at least one surface of the current collector.

There can be provided a structure where a heat resistant layer is formed so as to cover the active material layer and the heat resistant layer can be formed so as to cover part or whole of the insulating layer. For example, as shown in FIG. 2, the surface of the active material layer can be covered with the heat resistant layer and the insulating layer such that the surface of the active material layer is not exposed.

Alternatively, there can be provided a structure where the heat resistant layer covering the active material layer is formed and the insulating layer can cover part of the heat resistant layer. For example, as shown in FIG. 3, the surface of the active material layer can be covered with the heat resistant layer and the insulating layer such that the surface of the active material layer is not exposed.

The active material layer may have an inclined portion gradually reduced in thickness toward an end portion of the active material layer non-formation portion side.

In this case, one end of the insulating layer may be positioned on the inclined portion, and the other end may be formed on the surface of the current collector (active material layer non-formation portion).

The inclined portion may further have a stepped portion. The stepped portion may be formed of a portion comprising a surface having a large inclination angle relative to the plane of the current collector and a surface having a small inclination angle to the plane, the surfaces being continuously formed, for example, like a portion represented by reference symbol 2s in FIG. 4. The stepped portion corresponds to a recess present along the longitudinal direction of the inclined portion (the direction along the end portion of the active material layer: the direction from the front of the paper of the drawing toward the back in FIG. 4). The depth of the recess is preferably the same or more as the thickness of the insulating layer or the heat resistant layer on the active material layer, and more preferably, the same as the total thickness of the insulating layer and the heat resistant layer on the active material. At this time, the depth of the recess is preferably the same or less as the total thickness of the insulating layer and the heat resistant layer on the active material layer plus the thickness of the insulating layer or the heat resistant layer. Since an end portion of the insulating layer and an end portion of the heat resistant layer are stacked at the recess, a local increase in thickness can be suppressed. As a result, using the electrode, a more highly reliable battery can be provided.

The first resin, third resin and fourth resin each are preferably a fluororesin.

One end of the heat resistant layer is positioned on the surface of the active material layer at the inclined portion and the end of the heat resistant layer can be covered with the insulating layer.

One end of the insulating layer is positioned on the surface of the active material layer at the inclined portion and the end of the insulating layer can be covered with the heat resistant layer.

According to an exemplary embodiment, even if an electrode comprising an active material layer, an insulating layer and a heat resistant layer is formed, mutual layers are combined with the resins contained in individual layers and adhesion increases. Because of this, a lithium ion secondary battery rarely separated between the insulating layer and the heat resistant layer can be provided.

Since the heat resistant layer can be formed while overlapping with part or whole of the insulating layer, positioning accuracy conventionally required is not needed, with the result that high productivity can be obtained.

Since an end of each of the heat resistant layer and the insulating layer is disposed on an inclined portion where a portion of the active material layer is reduced in thickness, a local increase in thickness of a power generating element can be suppressed. If pressure is equally applied to the entire active material layer of the power generating element from, e.g., an outer case, time-dependent electrical characteristics tend to be stabilized. For the reason, a local increase in thickness is avoided and thereby a highly reliable battery can be provided. To avoid a local increase in thickness, on at least one surface of a current collector, at a portion of the active material layer at which the heat resistant layer and insulation layer are overlapped, the total thickness of the active material layer, heat resistant layer and insulating layer is preferably smaller than the thickness of another portion at which the active material layer and the heat resistant layer are overlapped. At this time, the thickness of the insulating layer portion on the current collector is preferably smaller than the total thickness of the active material layer, heat resistant layer and insulating layer at a portion of the active material layer at which the heat resistant layer and the insulation layer are overlapped.

When an electrode sheet is wound up in the form of a roll, since a locally large thickness portion is not present, occurrence of, e.g., cracks at a roll-style electrode can be suppressed.

When the insulating layer is stacked on the heat resistant layer at an end portion of the active material layer (the insulating layer is formed as the outermost surface), an effect of preventing fall of e.g., ceramic particles contained in the heat resistant layer can be obtained.

According to an exemplary embodiment, an electrode can be produced by a production method including the following steps:

(A) a step of forming an active material layer on a current collector,

(B) a step of forming an insulating layer on an end portion of the active material layer so as to cover the boundary between an active material layer formation portion and a non-formation portion thereof on the current collector, and

(C) a step of forming a heat resistant layer on the active material layer.

If step (B) is carried out before step (C), the heat resistant layer covering not only part or whole of the insulating layer but also a surface of the active material layer, can be formed (for example, FIG. 2).

If step (C) is carried out before step (B), the insulating layer covering not only part of the heat resistant layer but also the boundary between an active material layer formation portion and a non-formation portion thereof, can be formed (for example, FIG. 3).

Now, exemplary embodiments will be described with reference to the accompanying drawings.

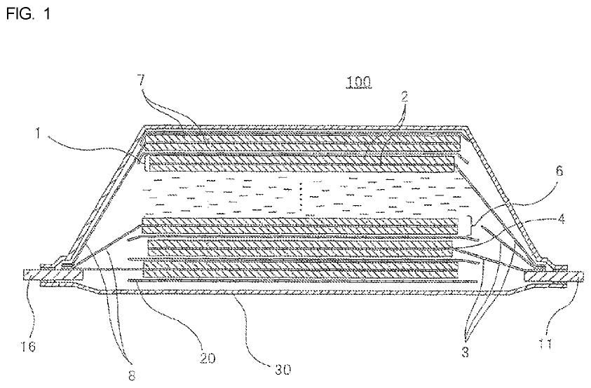

FIG. 1 schematically shows a structure of a lithium ion secondary battery.

According to an exemplary embodiment, a lithium ion secondary battery 100 has a power generating element in which positive electrodes 1 and negative electrodes 6 are alternately stacked with a separator 20 interposed between each of them or alternatively a power generating element formed by winding a laminate prepared by stacking the positive electrode 1 and the negative electrode 6 via the separator 20. The power generating element is housed together with an electrolytic solution in an outer container. In FIG. 1, the outer container is formed of a flexible film 30. To the positive electrode 1 of a power generating element, one end of a positive electrode terminal 11 is connected. To negative electrode 6, one end of a negative electrode terminal 16 is connected. The other end of the positive electrode terminal 11 and the other end of the negative electrode terminal 16 are separately pulled out from the outer container.

The positive electrode 1 has a positive electrode current collector 3, a positive electrode active material layer 2 formed of a mixture comprising an active material and a binder, and a positive electrode active material layer non-formation portion. Similarly, the negative electrode 6 has a negative electrode active material layer 2 and a negative electrode active material layer non-formation portion.

The positive electrode terminal 11 is fixed to the positive electrode active material layer non-formation portion with, e.g., ultrasonic welding and electrical connection is ensured. Similarly, the negative electrode terminal 16 is electrically connected to the negative electrode active material layer non-formation portion. In a laminated-type battery, as shown in FIG. 1, the positive electrode active material layer non-formation portion and the negative electrode active material layer non-formation portion are each separately connected to an electrode terminal having the corresponding polarity. In contrast, in the case of a roll-style battery, a pair of electrodes including a positive electrode and a negative electrode is wound up. In FIG. 1, 1 to 2 active material layer non-formation portions are connected to an electrode terminal per round; however, electrical connection need not be made with a plurality of sites.

FIG. 2 is an enlarged sectional view schematically showing an end portion of the electrode according to a first exemplary embodiment.

An insulating layer 9 covers a boundary 4 between a positive electrode active material layer formation portion and a non-formation portion in the positive electrode 1 and is formed over the formation portion and the non-formation portion. Further, a heat resistant layer 5 is formed on the positive electrode active material. In FIG. 2, the end portion of the insulating layer 9 which is closer to the positive electrode active material layer, is covered with the heat resistant layer 5.

Since the heat resistant layer is arranged after the insulating layer is formed, the boundary between the portion of the active material layer on which the insulating layer is present and the portion thereof on which the insulating layer is not present, can be covered. Even if the boundary of the insulating layer is bulged when surface tension is applied thereto, since the boundary is covered with the heat resistant layer, a smooth surface is resulted and local unevenness of the electrode is likely to be suppressed. More specifically, even though the insulating layer is not provided on the boundary with a higher positional accuracy, formation of locally unevenness of the electrode can be suppressed.

A negative electrode active material layer 7 is positioned so as to face the position at which the positive electrode active material layer 2 is present and has a larger outer size than the periphery of the positive electrode active material layer. A separator 20 has a shape equal to or larger than the shape of the periphery of the negative electrode active material layer.

Examples of the positive electrode active material include a layered material of, e.g., lithium nickelate, lithium cobaltite and nickel/lithium cobaltite; a spinel material such as lithium manganate; and an olivine material such as iron phosphate. These may be used as a mixture.

The positive electrode active material layer can be obtained by appropriately adding, e.g., a binder and a conductive auxiliary agent to a positive electrode active material, mixing/dispersing together with a solvent to form a slurry, applying the slurry to a positive electrode current collector by means of a doctor blade, a die coater or a gravure coater or by a method of transfer printing or vapor deposition, and drying the slurry.

The negative electrode active material layer can be obtained by appropriately adding, e.g., a binder and a conductive auxiliary agent to a negative electrode active material, mixing/dispersing together with a solvent to form a slurry, applying the slurry to a negative electrode current collector in the same manner as in the positive electrode and drying the slurry.

As the binder, a fluororesin, an acrylic resin, an epoxy resin, a styrene resin, a urethane resin, a phenolic resin, a butadiene resin, a cellulose resin, a polyolefin resin, a polyester resin, a polyurethane resin etc., which may be modified, copolymerized, etc., may be used alone or in combination.

The separator is formed of, e.g., porous film, a woven fabric, a nonwoven fabric made of a resin, if necessary, inorganic particles may be added to the separator.

To the resistant layer, an insulating substance such as an oxide, a nitride, a sulfide and a carbide can be added and preferably insulating particles of, e.g., titanium oxide, aluminum oxide and magnesium oxide are added.

The heat resistant layer can be formed by applying a dispersion solution comprising insulating particles and a binder, onto a positive electrode active material layer and drying the dispersion solution, etc. If the same resin as used in the active material layer is used in the heat resistant layer, the binding between insulating particles of the heat resistant layer to each other and the adhesion between the insulating particles and the active material layer can be ensured.

In the insulating layer, a fluororesin, an acrylic resin, an epoxy resin, a styrene resin, a urethane resin, a phenolic resin, a butadiene resin, a cellulose resin, a polyolefin resin, a polyester resin, a polyurethane resin, etc., which may be modified, copolymerized etc., may be used alone or in combination. The insulating layer is formed by preparing a solution or dispersion solution made by dissolving or dispersing a resin selected in accordance with the type of resin in a solvent, applying the solution or dispersion solution and evaporating the solvent; formed by melting a resin at high temperature, applying a melt and cooling it; or formed by applying pressure or UV rays to a resin or reacting a resin with moisture in the air. To reduce the occurrence of separation between the insulating layer and the active material layer/the heat resistant layer, it is preferable to select the same type of resin components as that contained in the active material layer/heat resistant layer. If a resin which can be dissolved in a solvent, applied and dried is selected, since the resin penetrates into voids of the active material layer and the heat resistant layer, the adhesion is particularly effectively enhanced. The types of resin components for use in the insulating layer, heat resistant layer and active material layer may be mutually different or the same.

The positive electrode active material layer and negative electrode active material layer are each compressed together with a current collector and formed with a desired density. At this time, the heat resistant layer may be arbitrarily formed before or after the active material layer is compressed. The heat resistant layer is preferably compressed to control its density.

As the outer container, e.g., a case formed of a flexible film 30 and a can rarely deflected can be used. In view of lightweight of a battery, the flexible film 30 is preferably used.

The positive electrode terminal 11 can be formed of aluminum or an aluminum alloy.

The negative electrode terminal 16 can be formed of, e.g., copper, a copper alloy or each of these plated with nickel.

FIG. 3 is an enlarged sectional view schematically showing an end portion of the electrode according to a second exemplary embodiment.

In the exemplary embodiment, a heat resistant layer 15 is formed on the surface of the positive electrode active material layer 2. At an end portion of the positive electrode active material layer, an insulating layer 19, which covers the boundary of an active material layer formation portion and a non-formation portion thereof and a part of the heat resistant layer, is formed.

If the end portion of the electrode active material layer is formed such that the thickness is gradually reduced from the active material layer toward the boundary, the heat resistant layer 15 is formed so as to cover at least the center portion of the active material layer 2 and part or whole of the portion gradually reduced in thickness. In the sectional view of FIG. 3, an end of the heat resistant layer 15 is preferably positioned on the portion of the active material layer gradually reduced in thickness. When the electrode is cut out into a desire shape as described later, if the electrode is cut at a position comprising no heat resistant layer, a rate of insulating particles falling from the heat resistant layer can be reduced.

In the case where the heat resistant layer is positioned even in the portion of the active material layer gradually reduced in thickness, since the portion of the active material layer having a constant thickness and heat resistant layer tend to extend in a direction parallel to the current collector in the step of compressing the electrode, stress is applied to a portion of the heat resistant layer formed on the portion gradually reduced in thickness. As a result, in some cases, insulating particles may come to be easily fall. In the exemplary embodiment, since the insulating layer 19 is further formed on the heat resistant layer on the portion gradually reduced in thickness, an effect of suppressing fall of, e.g., the insulating particles can be obtained. In the case of attaching an insulating tape having an adhesive layer on one of the surfaces of a substrate formed of, e.g., polypropylene, a difference in height at the end of the tape is likely to cause a local unevenness; however, the insulating layer can be formed by applying and drying a resin without producing extreme difference in height.

FIG. 4 is an enlarged sectional view schematically showing an end portion of the electrode according to a third exemplary embodiment.

In the exemplary embodiment, stepped portion 2s is formed in the inclined end portion of positive electrode active material layer. One end of the insulating layer 29 is positioned on the stepped portion and the insulating layer 29 covers the boundary 4 of the active material layer. The other end of the insulating layer 29 is positioned on the current collector. The one end of the insulating layer is covered with the heat resistant layer 25. Since the insulating layer 29 and heat resistant layer 25 are overlapped at the stepped portion, it is possible to suppress a local increase in thickness due to the presence of the insulating layer and the heat resistant layer. Since the thickness of the insulating layer to be arranged on the stepped portion can be increased just by the height of the stepped portion, a more highly safe electrode and battery can be provided.

### EXAMPLES

### Example 1

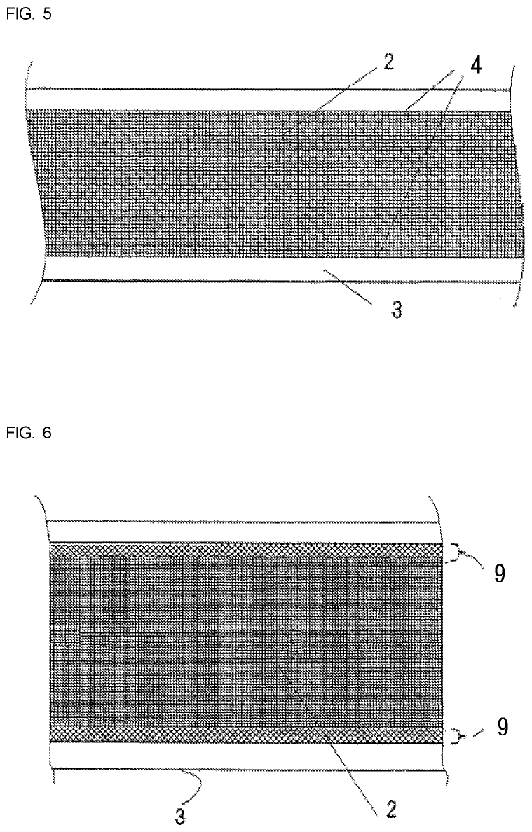

FIGS. 5 to 8 show production steps of a lithium ion secondary battery of the present invention.

A mixture of LiNi_{0.8}Co_{0.1}Mn_{0.1}O₂ and LiNi_{0.8}Co_{0.15}Al_{0.05}O₂ serving as a positive electrode active material, carbon black serving as a conductive agent, and PVdF (polyvinylidene fluoride) serving as a binder were mixed and dispersed in an organic solvent to prepare a slurry. The slurry was applied to a long positive electrode current collector formed mainly of aluminum and having a thickness of 20 μm by means of a die coater and wound up in a single direction while drying the slurry to form a roll. In this manner, a positive electrode active material layer 2 was formed on both surfaces of the positive electrode current collector, as shown in FIG. 5. On the both edges of a positive electrode current collector 3 in a width direction, a positive electrode active material non-formation portion where no positive electrode active material is formed, was provided. The boundary 4 between the positive electrode active material layer 2 and the positive electrode active material non-formation portion is arranged in parallel to the longitudinal direction of the current collector.

As shown in FIG. 6, the insulating layer 9 was then formed so as to cover an edge of the positive electrode active material layer, the boundary 4 and part of the non-formation portion of the positive electrode current collector. The insulating layer 9 was formed by applying a liquid prepared by dissolving PVdF in a solvent, to a current collector along the longitudinal direction and dried to evaporate the solvent.

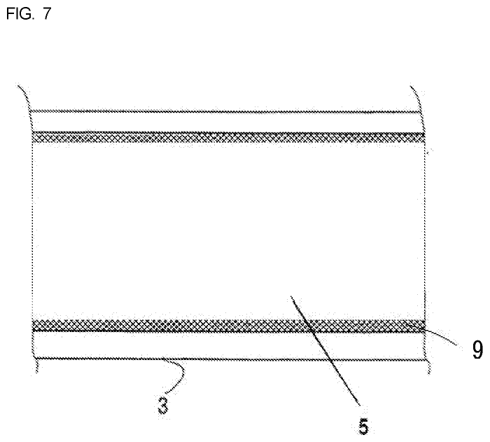

As shown in FIG. 7, the heat resistant layer 5 was then formed so as to cover the center portion of the positive electrode active material layer in the width direction and part of the insulating layer. The heat resistant layer was formed by applying a slurry prepared by dispersing Al₂O₃ together with PVdF in a solvent, followed by drying.

The sheet having the positive electrode active material layer, insulating layer and heat resistant layer formed therein was compressed to form an electrode sheet with a desired density having a layer thickness of 80 μm per side of the positive electrode current collector.

The film thickness from the center portion of the positive electrode active material layer to the boundary between the positive electrode active material layer formation portion and the non-formation portion thereof was measured to observe whether insulating particles fall from the heat resistant layer or not.

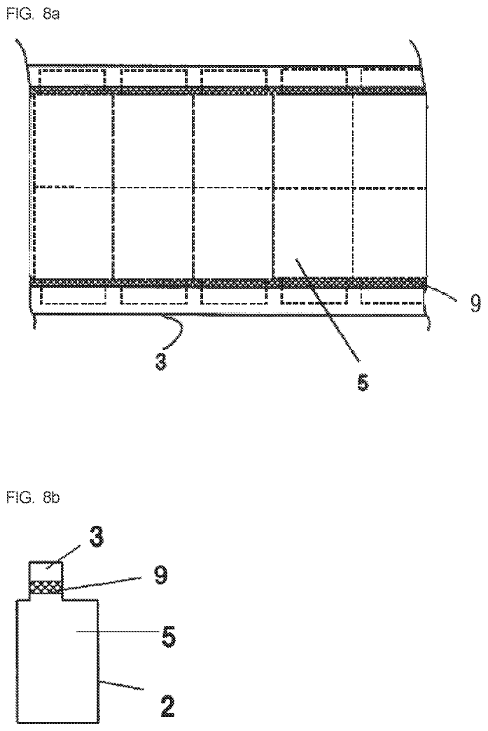

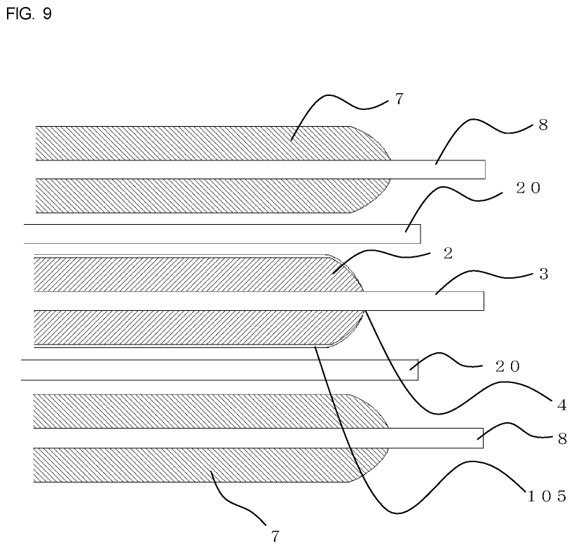

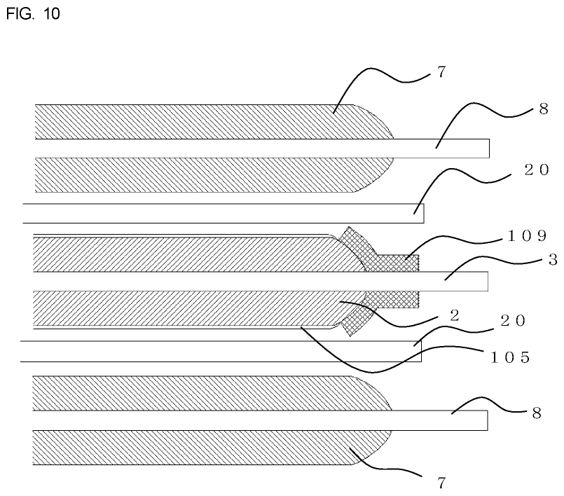

From the electrode sheet, electrode pieces as shown in FIG. 8 (a) and FIG. 8 (b) were cut out and used as positive electrode pieces.

Graphite serving as a negative electrode active material and styrene butadiene rubber serving as a binder were dispersed in water to obtain a slurry-like negative electrode mixture. The mixture was applied to a negative electrode current collector of 15 μm in thickness by means of a die coater, dried and compressed, and thereafter, cut into pieces having a predetermined shape to obtain negative electrode pieces each including the negative electrode active material layer having a thickness of 50 μm per side of the current collector.

The positive electrode pieces (20 pieces) and the negative electrode pieces (21 pieces) were stacked via a separator formed of polypropylene as a main component and having a thickness of 25 μm. The laminate was housed together with an electrolytic solution in an outer container to obtain a laminated-type lithium ion secondary battery. Note that, a positive electrode terminal electrically connected to a positive electrode of the power generating element and a negative electrode terminal electrically connected to a negative electrode were pulled out from the outer container.

The lithium ion battery prepared as mentioned above was subjected to a charge/discharge cycle test. After the cycle was repeated 300 times at 45° C., the capacity retention rate was checked; at the same time, a battery element was taken out and the portion at which the insulating layer was formed was observed. In the cycle test, the battery was charged at constant current charge conditions of 1 C up to upper limit voltage of 4.2 V, and subsequently, charged at a constant voltage of 4.2 V. The charging time in total was 2.5 hours. Subsequently, the battery was discharged at a constant current discharge at 1 C up to 2.5 V. One cycle was determined to consist of these operations.

### Example 2

On the surface of the positive electrode active material layer 2 shown in FIG. 5, a heat resistant layer was formed. An edge portion of the heat resistant layer in the width direction of the current collector was positioned at the portion where the positive electrode active material layer is gradually reduced in thickness. Then, an insulating layer was arranged such that the insulating layer covers the boundary between the positive electrode active material layer formation portion and the non-formation portion thereof; one end of the insulating layer covers the heat resistant layer and the other end is positioned on the current collector. A laminated-type lithium ion secondary battery having the end portion as shown in FIG. 3 was produced in the same manner as in Example 1 except the conditions mentioned above, and then, evaluated.

### Example 3

After a positive electrode active material layer was applied, a heat resistant layer was formed in a wet state, and then, dried and compressed. Further, an insulating layer was formed on the boundary between an active material layer formation portion and a non-formation portion thereof. A laminated-type lithium ion secondary battery having the end portion as shown in FIG. 3 was produced in the same manner as in Example 2 except the conditions mentioned above, and then, evaluated.

### Example 4

At an inclination portion of an end portion of the positive electrode active material, a stepped portion was formed. An end portion of the insulating layer was positioned on the stepped portion such that the end portion of the insulating layer and an end portion of the heat resistant layer were overlapped at the stepped portion. A laminated-type lithium ion secondary battery having the end portion as shown in FIG. 4 was produced in the same manner as in Example 1 except the conditions mentioned above, and then, evaluated.

### Comparative Example 1

At an end portion of the positive electrode active material layer, an insulation tape having a two-layered structure consisting of an acrylic adhesive layer and a polypropylene layer was arranged as an insulating layer such that the acrylic adhesive layer faces the positive electrode active material layer and so as to cover the boundary 4; and thereafter, a heat resistant layer was formed so as to cover the end portion of the insulation tape. A layered lithium ion secondary battery was produced in the same manner as in Example 1 except the conditions mentioned above, and then, evaluated.

In Examples 1 to 4, in the portion at which a heat resistant layer and an insulating layer are formed, neither a portion the thickness of which is higher than that of the center portion of the electrode at which the heat resistant layer and the active material layer are arranged nor fall of the insulating particles from the heat resistant layer, was observed. A cyclability of 85% or more of the initial value was successfully maintained after 300 cycles in any one of Examples.

In Comparative Example 1, it was confirmed that an insulating member and a heat resistant layer were separated in some of the batteries, which exhibited a cyclability of 80% or less after 300 cycles.

In the foregoing, the present invention has been described with reference to the exemplary embodiments and the Examples; however, the present invention is not limited to the exemplary embodiments and the Examples. Various modifications understandable to those skilled in the art may be made to the constitution and details of the present invention within the scope thereof.

### INDUSTRIAL APPLICABILITY

A lithium ion secondary battery according to an exemplary embodiment is a lithium ion battery in which a positive electrode and a negative electrode are arranged so as to face each other, and the battery is suitable for ensuring safety of a battery using an active material having particularly a high energy density.

The present application claims the right of priority based on Japanese Patent Application No. 2016-60266 filed Mar. 24, 2016, and the entire disclosure of which is incorporated herein by reference.

### REFERENCE SIGNS LIST

1 Positive electrode
2 Positive electrode active material layer
2s Stepped portion
3 Positive electrode current collector
4 Boundary
5, 15, 25, 105 Heat resistant layer
6 Negative electrode
7 Negative electrode active material layer
8 Negative electrode current collector
9, 19, 29, 109 Insulating layer
11 Positive electrode terminal
16 Negative electrode terminal
20 Separator
100 Lithium ion secondary battery

1. A lithium ion secondary battery comprising:
a positive electrode comprising a positive electrode active material layer comprising a positive electrode active material and a first resin, the positive electrode active material layer being formed on at least one surface of a positive electrode current collector, and a positive electrode active material layer non-formation portion having no positive electrode active material layer formed thereon;
a negative electrode comprising a negative electrode active material layer comprising a negative electrode active material and a second resin, the negative electrode active material layer being formed on at least one surface of a negative electrode current collector, and a negative electrode active material layer non-formation portion having no negative electrode active material layer formed thereon; and
a separator,
wherein the positive electrode and the negative electrode mutually face, with the separator interposed therebetween;
a boundary between the positive electrode active material layer and the positive electrode active material layer non-formation portion is covered with an insulating layer, and the insulating layer comprises a third resin; and
a heat resistant layer covering the surface of the positive electrode active material layer is formed, the heat resistant layer overlaps with the insulating layer at an end portion of the positive electrode active material layer, and the heat resistant layer comprises a fourth resin.

2. The lithium ion secondary battery according to claim 1, wherein the positive electrode active material layer includes an inclined portion gradually reduced in thickness toward an end portion of the positive electrode active material layer non-formation portion side.

3. The lithium ion secondary battery according to claim 2, wherein an end of the insulating layer is positioned on the inclined portion, and the other end of the insulating layer is formed on a surface of the positive electrode current collector.

4. The lithium ion secondary battery according to claim 2, wherein the inclined portion has a stepped portion.

5. The lithium ion secondary battery according to claim 1, wherein the first resin, the third resin and the fourth resin each are a fluororesin.

6. An electrode comprising an active material layer comprising an active material and a first resin, the active material layer being formed on at least one surface of a current collector, and an active material layer non-formation portion having no active material layer formed thereon,
wherein a boundary between the active material layer and the active material layer non-formation portion is covered with an insulating layer, and the insulating layer comprises a third resin; and
a heat resistant layer covering the surface of the active material layer is formed, the heat resistant layer overlaps with the insulating layer at an end portion of the active material layer, and the heat resistant layer comprises a fourth resin.

7. The electrode according to claim 6, wherein the active material layer includes an inclined portion gradually reduced in thickness toward an end portion of the active material layer non-formation portion side.

8. The electrode according to claim 7, wherein an end of the insulating layer is positioned on the inclined portion, and the other end of the insulating layer is formed on a surface of the current collector.

9. The electrode according to claim 7, wherein the inclined portion further has a stepped portion.

10. The electrode according to claim 6, wherein the first resin, the third resin and the fourth resin each are a fluororesin.

11. A method for producing the electrode according to claim 6, the method comprising:
forming an active material layer on a current collector;
forming an insulating layer on an end portion of the active material layer so as to cover a boundary between an active material layer formation portion and an active material layer non-formation portion on the current collector; and
forming a heat resistant layer on the active material layer.

12. The lithium ion secondary battery according to claim 1, wherein the heat resistant layer is formed so as to cover part or whole of the insulating layer as well as the surface of the positive electrode active material layer.

13. The lithium ion secondary battery according to claim 4, wherein an end portion of the insulating layer and an end portion of the heat resistant layer are stacked at the stepped portion.

14. The electrode according to claim 6, wherein the heat resistant layer is formed so as to cover part or whole of the insulating layer as well as the surface of the active material layer.

15. The electrode according to claim 9, wherein an end portion of the insulating layer and an end portion of the heat resistant layer are stacked at the stepped portion.
